(19) United States
(12) Patent Application Publication
(10) Pub. No.: US 2004/0122791 A1
(43) Pub. Date: Jun. 24, 2004

(54) Method and system for automated source code formatting

(76) Inventors: Brian S. Sea, Harahan, LA (US); Christopher J. Kiick, Plano, TX (US); Jeffrey J. Naset, Richardson, TX (US)

Correspondence Address: HEWLETT-PACKARD COMPANY, Intellectual Property Administration, P.O. Box 272400, Fort Collins, CO, 80527-2400, US

(21) Appl. No.: 10/324,286

(22) Filed: Dec. 19, 2002

(51) Int. Cl. G06F 7/00

(52) U.S. Cl. 707/1

(57) ABSTRACT

A method and system for automated source code formatting is described. In one embodiment, the invention is directed to a method of automatically reformatting a source file stored in a database accessible by more than one user, wherein each source file stored in the database is stored in a standard file format. The method comprises selecting a source file from the database, identifying a first definition file specifying a user-preferred file format, reformatting the selected source file from the standard file format to the user-preferred format, and subsequently re-reformatting the reformatted selected file in the standard file format.

### BACKGROUND

Productivity in the workplace is paramount to employers. To many employees, familiarization with the surrounding environment increases their productivity. To a computer programmer, one aspect of such familiarization is the formatting of source code upon which the programmer is working.

Source code typically comprises a text file that is readable both by humans and computers. Specifically, humans read and write source code and an appropriate computer language compiler turns it into executable computer program code. As far as the compiler is concerned, as long as the code is arranged in the right order, it makes no difference how the printed code looks. In contrast, human users are typically fairly concerned with the appearance of the code in terms of format, such as line breaks, indentation, spacing, etc. Such formatting details tend to make source code more or less easily read by a user.

It follows, therefore, that not every user prefers source code to be presented in the same format; that is, different users will likely prefer to read and write the same source code in different formats. In fact, the format of source code and a programmer's familiarity and comfort level therewith can have a direct impact (positive or negative) on the programmer's productivity.

There currently exists tools that are capable of formatting source code according to a particular formatting style regardless of the original format of the code; however, obstacles currently exist to using such tools. In particular, most large computer program developers utilize some type of source code control mechanism, referred to herein as a source code control system (“SCCS”), that serves as a repository for all source code files under development. When an employee programmer needs to work on a particular file, he must check it out of the SCCS and subsequently check the file back in to the SCCS after modifying it.

In development environments that employ an SCCS, any changes to the code contained in the file, including mere formatting changes that do not affect the substance of the code and how it is executed, are tracked by the SCCS. In situations in which a file is completely reformatted using a formatting tool subsequent to being checked out of the SCCS, it is often difficult to ascertain what substantive changes made to the file, e.g., in response to a customer's inquiry regarding such changes.

### SUMMARY

Accordingly, the present disclosure advantageously provides a method and system for automated source code formatting. In one aspect, a method is described for automatically reformatting a source file stored in a database accessible by more than one user, wherein each source file stored in the database is stored in a standard file format, the method comprising selecting a source file from the database, identifying a first definition file specifying a user-preferred file format, reformatting the selected source file from the standard file format to the user-preferred format, and subsequently re-reformatting the reformatted selected file in the standard file format.

### BRIEF DESCRIPTION OF THE DRAWINGS

FIG. 1 is a block diagram of a system for automated source code formatting in accordance with one embodiment;

FIG. 2 is an embodiment of the operation of the system of FIG. 1; and

FIG. 3 is another embodiment of the operation of the system of FIG. 1.

### DETAILED DESCRIPTION OF THE DRAWINGS

In the drawings, like or similar elements are designated with identical reference numerals throughout the several views thereof, and the various elements depicted are not necessarily drawn to scale.

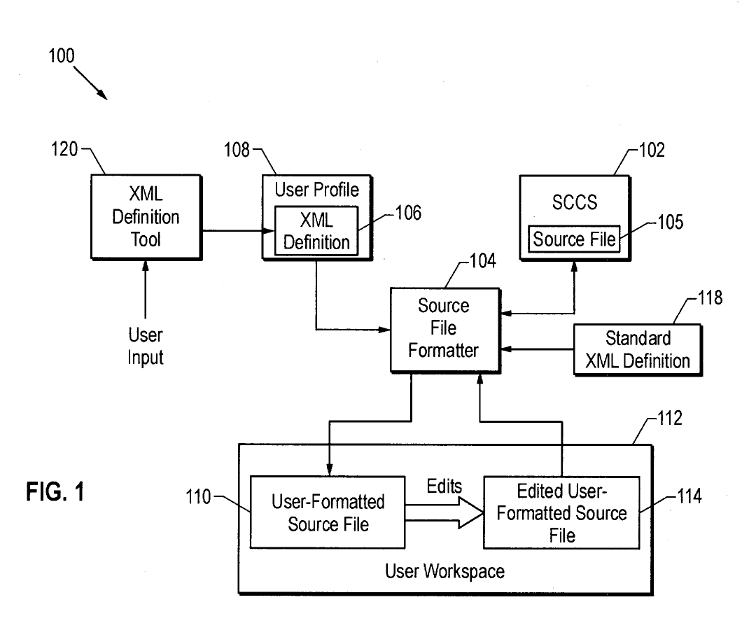

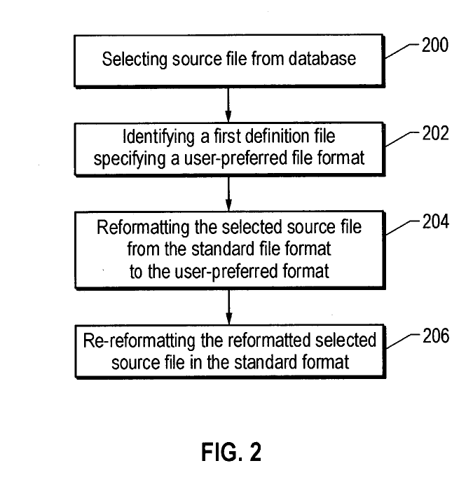

FIG. 1 is a block diagram of a system 100 for automated source code formatting in accordance with one embodiment. As illustrated in FIG. 1, the system 100 is implementable as a computer-based system that includes an SCCS 102 in which is stored a plurality of source files in a common standard format. It will be recognized that this common standard format may be one that the majority of programmers that will be accessing source files from the SCCS prefer or some arbitrary standard selected for other reasons. The system 100 further includes a source code formatter 104 for reformatting a source file, such as a source file 105, checked out from the SCCS 102 from the standard format to a format specified in a user's XML file definition 106. In one embodiment, the XML file definition 106 may be stored in a user profile 108 associated with a user. As will be described in greater detail below with reference to FIG. 2, a user-formatted source file 110, which comprises the source file 105 reformatted by the source code reformatter 104 as suggested above, may be edited by a user via a user workspace 112. The edited user-formatted file 114 is then returned to the common standard format by the formatter 104 as defined by a standard XML definition 118.

It will be recognized by those of ordinary skill in the art that XML is a meta-language that allows authors to create their own customized tags to identify different types of data. As such, XML is a standard and can be produced, edited, and read by many applications. In particular, XML is short for Extensible Markup Language, a specification developed by the World Wide Web Consortium (“W3C”). XML is a pared-down version of Standard Generalized Markup Language (“SGML”), designed especially for Web documents. XML allows designers to create their own customized tags, enabling the definition, transmission, validation, and interpretation of data between applications and between organizations. W3C is an international consortium of companies involved with the Internet and the Web. The W3C was founded in 1994 by Tim Berners-Lee, the original architect of the World Wide Web. The organization's purpose is to develop open standards so that the Web evolves in a single direction rather than being splintered among competing factions.

In one embodiment, an XML definition tool 120 is provided for enabling a user to facilitate creation of the user XML definition 106 for use in formatting source files from the SCCS 102. In one embodiment, the tool 120 is implemented as a conventional GUI “Wizard” that presents the user with a series of queries the responses to which are used to create the user XML definition file 106 customized for the user.

An embodiment of the operation of the system 100 for automatically reformatting a source file stored in a standard format in a database that is accessible to more than one user may now be set forth as follows. Referring to FIG. 2, in block 200, a source file is selected from the database. Thereafter, a first definition file that specifies a user-preferred file format is identified (block 202). The selected source file is then reformatted from the standard file format to the user-preferred format (block 204). Subsequently, the reformatted selected source file is re-reformatted in the standard file format (block 206).

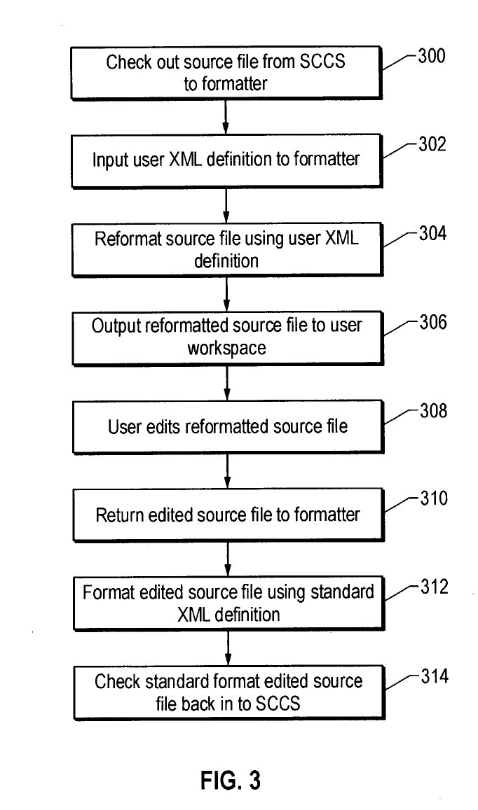

Another embodiment of the operation of the system 100 will now be described in greater detail with reference to FIG. 3. In block 300, a designated source file is checked out of the SCCS 102 and input to the formatter 104. In block 302, an XML definition file is input to the formatter 104. It will be recognized that in block 302, the XML definition file may be specified in a variety of ways. For example, the XML definition file may be associated with a particular user's user profile or the user may be offered a variety of XML definition files from which to select. In block 304, the formatter 104 formats the source file input thereto in block 300 as specified in the user XML definition file input thereto in block 302. In block 306, the user-formatted source file is output to the user workspace 112.

Once the user has completed modification of the user-formatted source file, in block 308, the edited user-formatted source file is returned to the formatter 104. In block 310, the standard XML definition file 118 is input to the formatter 104. In block 312, the formatter 104 returns the source file to its original format using the standard XML definition file. The effect of block 312 is to remove from the source file all formatting changes introduced in block 304, as well as any other formatting changes that may have been made manually by the user during the editing process (block 308). In block 314, the standard formatted source file is returned to the SCCS 105. As a result, the only changes that are detected and tracked by the SCCS 102 are substantive changes made by the user during the editing process (block 308).

The following is a simple C++ language code segment comprising a partial declaration of a class “Container”:

class Container
{
public:
// declarations of public members
protected:
double m_fLength; // length of container
double m_fWidth; // width of container
double m_fHeight; // height of container
};
Compare the foregoing code segment, hereinafter referred to
as Code Segment Example 1, with the following code segment,
hereinafter referred to as Code Segment Example 2:
class Container
{

public:
// declarations of public members
protected:

double m_fLength; // length of container
double m_fWidth; // width of container
double m_fHeight; // height of container

}
;

Clearly, when the two foregoing code segments are compared, although there are differences in formatting between the two, there are no substantive differences therebetween. Therefore, for purposes of example herein, it will be assumed that Code Segment Example 1 comprises a file representing a partial definition for the class Container in the common standard format in which source files are stored in the SCCS 102 (FIG. 1). Similarly, it will be further assumed that Code Segment Example 2 comprises the same file representing the same partial definition for the class Container after it has been formatted by the source code formatter 104 in accordance with the user's XML file definition 106; that is, it is in a user-defined format.

If Code Segment Example 2 as it appears above were returned to the SCCS 102 in accordance with the embodiment described in connection with FIG. 2, it would be returned to the common standard format, as represented by Code Segment Example 1, by the formatter 104. The SCCS 102 would detect no changes to the file.

Consider the following code segment, hereinafter referred to as Code Segment Example 3:

class Container
{

public:
// declarations of public members
protected:

double m_fLength; // length of container
double m_fWidth; // width of container
double m_fHeight; // height of container
double m_fArea; // area of container

}
;

Comparing Code Segment Example 3 with Code Segment Examples 1 and 2, it will be noted that there is at least one substantive difference between the two; namely, the declaration of an additional public member “double m_fLength” representing the area of Container. It will be further noted that the format of Code Segment Example 3 is the same as that of Code Segment Example 2. Therefore, for purposes of example herein, it will again be assumed that Code Segment Example 1 comprises a file representing a partial definition for the class Container in the common standard format in which source files are stored in the SCCS 102 (FIG. 1). Similarly, it will be further assumed that Code Segment Example 3 comprises the same file representing the same partial definition for the class Container after it has been formatted by the source code formatter 104 in accordance with the user's XML file definition 106; that is, it is in a user-defined format and subsequently edited via the user workspace 112; that is, it is the edited user-formatted file.

If Code Segment Example 3 as it appears above were returned to the SCCS 102 in accordance with the embodiment described in connection with FIG. 2, it would be returned to the common standard format, as represented by Code Segment Example 1, by the formatter 104. The SCCS 102 would detect and note the change to the file; namely, the addition of the line:

double m_fArea; //area of container

An implementation of the scheme described herein thus provides method and system for automated source code formatting. The operation and construction of the embodiments will be apparent to those skilled in the art from the foregoing Detailed Description. While the system and method shown and described have been characterized as being exemplary, it should be readily understood that various changes and modifications could be made therein without departing from the scope hereof as set forth in the following claims. For example, means other than XML definition files for specifying the user-selected and standard formats may be employed. Moreover, the teachings hereof may be practiced on any computer platform including uniprocessor systems, multiprocessor systems, et cetera. Accordingly, all such modifications, extensions, variations, amendments, additions, deletions, combinations, and the like are deemed to be within the ambit of the present invention whose scope is defined solely by the claims set forth hereinbelow.

What is claimed is:

1. A method of automatically reformatting a source file stored in a database accessible by more than one user, wherein each source file stored in the database is stored in a standard file format, the method comprising:
selecting a source file from the database;
identifying a first definition file specifying a user-preferred file format;
reformatting the selected source file from the standard file format to the user-preferred format; and
subsequently re-reformatting the reformatted selected source file in the standard file format.

2. The method of claim 1 wherein the first definition file is an XML file.

3. The method of claim 1 wherein the second definition file is an XML file.

4. The method of claim 1 further comprising outputting the reformatted selected source file to a user workspace, wherein a user is able to edit the reformatted selected source file via the user workspace.

5. The method of claim 4 wherein the subsequently re-reformatting the reformatted selected source file in the standard file format comprises re-reformatting the edited reformatted selected source file in the standard format.

6. The method of claim 1 further comprising returning the re-reformatted selected source file to the database.

7. The method of claim 6 wherein the database comprises a source code control system (“SCCS”) for tracking changes to source files stored therein and wherein the selecting comprises checking a selected source file out of the SCCS and wherein the returning the re-reformatted selected source file comprises checking the re-reformatted selected source file back into the SCCS.

8. A system for automatically reformatting a source file stored in a database accessible by more than one user, wherein each source file stored in the database is stored in a standard file format, the system comprising:
means for selecting a source file stored in the database;
means for identifying a first definition file specifying a user-preferred file format;
means for reformatting the selected source file from the standard file format to the user-preferred format; and
means for subsequently re-reformatting the reformatted selected source file in the standard file format.

9. The system of claim 8 wherein the first definition file is an XML file.

10. The system of claim 8 wherein the second definition file is an XML file.

11. The system of claim 8 further comprising means for outputting the reformatted selected source file to a user workspace, wherein a user is able to edit the reformatted selected source file via the user workspace.

12. The system of claim 11 wherein the means for subsequently re-reformatting the reformatted selected source file in the standard file format comprises means for re-reformatting the edited reformatted selected source file in the standard format.

13. The system of claim 8 further comprising means for returning the re-reformatted selected source file to the database.

14. The system of claim 13 wherein the database comprises a source code control system (“SCCS”) for tracking changes to source files stored therein and wherein the means for selecting comprises means for checking a selected source file out of the SCCS and wherein the means for returning the re-reformatted selected source file comprises means for checking the re-reformatted selected source file back into the SCCS.

15. A system for automatically reformatting a source file stored in a source code control system (“SCCS”), wherein each source file stored in the SCCS is stored in a standard file format, the system comprising:
a definition file specifying a source file format; and
a formatter for receiving the definition file and a selected source file and reformatting the selected source file in the specified source file format.

16. The system of claim 15 wherein the definition file specifies a user-preferred file format and wherein the selected source file is received by the formatter from the SCCS.

17. The system of claim 16 further comprising a user workspace connected to the formatter, wherein the reformatted selected source file is output to the user workspace.

18. The system of claim 17 wherein the definition file specifies the standard file format and wherein the selected source file is received by the formatter from the user workspace.

19. The system of claim 18 wherein reformatted selected source file is returned to the SCCS.

20. The system of claim 15 wherein the definition file is an XML file.

21. A computer-readable medium operable with a computer to automatically reformat a source file stored in a database accessible by more than one user, wherein each source file stored in the database is stored in a standard file format, the medium having stored thereon:
computer-executable instructions for selecting a source file from the database;
computer-executable instructions for identifying a first definition file specifying a user-preferred file format;
computer-executable instructions for reformatting the selected source file from the standard file format to the user-preferred format; and
computer-executable instructions for subsequently re-reformatting the reformatted selected source file in the standard file format.

22. The medium of claim 21 further having stored thereon computer-executable instructions for outputting the reformatted selected source file to a user workspace, wherein a user is able to edit the reformatted selected source file via the user workspace.

23. The medium of claim 22 wherein the computer-executable instructions for subsequently re-reformatting the reformatted selected source file in the standard file format comprise computer-executable instructions for re-reformatting the edited reformatted selected source file in the standard format.

24. The medium of claim 21 further having stored thereon computer-executable instructions for returning the re-reformatted selected source file to the database.

25. The medium of claim 24 wherein the database comprises a source code control system (“SCCS”) for tracking changes to source files stored therein and wherein the computer-executable instructions for selecting comprise computer-executable instructions for checking a selected source file out of the SCCS and wherein the computer-executable instructions for returning the re-reformatted selected source file comprise computer-executable instructions for checking the re-reformatted selected source file back into the SCCS.

26. A computer configured to automatically reformat a source file stored in a source code control system (“SCCS”), wherein each source file stored in the SCCS is stored in a standard file format, the computer comprising:
means for receiving a definition file specifying a source file format and a selected source file; and
means for reformatting the selected source file in the specified source file format.

27. The computer of claim 26 wherein the definition file specifies a user-preferred file format and wherein the selected source file is received from the SCCS.

28. The computer of claim 26 further having connectable thereto means for editing the selected source file, wherein the reformatted selected source file is output to the editing means.

29. The computer of claim 28 wherein the definition file specifies the standard file format and wherein the selected source file is an edited file received from the editing means.

30. The computer of claim 29 further comprising means for returning the reformatted edited file to the SCCS.
